(19) United States
(12) Patent Application Publication
(10) Pub. No.: US 2019/0018564 A1
(43) Pub. Date: Jan. 17, 2019

(54) DISPLAY DEVICE AND TOUCH SENSING METHOD USING THE SAME

(71) Applicant: InnoLux Corporation, Miao-Li County (TW)

(72) Inventors: Kun-Yi CHEN, Miao-Li County (TW); I-An YAO, Miao-Li County (TW); Po-Yang CHEN, Miao-Li County (TW); Hsing-Yuan HSU, Miao-Li County (TW)

(21) Appl. No.: 16/002,020

(22) Filed: Jun. 7, 2018

(30) Foreign Application Priority Data
Jul. 13, 2017 (CN) 201710571691.4

(51) Int. Cl. G06F 3/0488; G06F 3/041; G06F 3/042

(52) U.S. Cl. CPC G06F 3/0488; G06F 3/0421; G06F 3/0412

(57) ABSTRACT

A display device is disclosed, which includes a display panel and a backlight module. The display panel includes: a first substrate; a first gate line, disposed on the first substrate; a second gate line, disposed on the first substrate and adjacent to the first gate line; a first data line, disposed on the first substrate and intersecting the first and the second gate lines; a sensing line, disposed on the first substrate, adjacent to the first data line, and intersecting the first and the second gate lines; and a photosensor, disposed on the first substrate and electrically connected to both the sensing line and the first gate line. The backlight module is disposed under the display panel and includes at least one visible light source and at least one infrared light source.

### CROSS REFERENCE TO RELATED APPLICATION

This application claims the benefits of the Chinese Patent Application Serial Number 201710571691.4, filed on Jul. 13, 2017, the subject matter of which is incorporated herein by reference.

### BACKGROUND

### 1. Field

The present disclosure relates to a display device and a method for sensing touch signals via the display device. More particularly, the disclosure relates to a display device with a relatively high aperture ratio and a touch sensing method using the same.

### 2. Description of Related Art

With continual advancements of the display technology, one major trend of the development of display panels is toward compactness, small thicknesses, and light weight. This explains why the mainstream display devices on the market are thin displays such as liquid-crystal displays (LCDs), organic light-emitting diode (LED) displays, and micro inorganic LED displays. In fact, thin displays have found extensive use in our daily lives, serving nowadays as the typical display devices of mobile phones, laptop computers, video cameras, still cameras, music players, mobile navigation devices, television sets, and so forth.

Another development trend is toward user-friendliness and simple operation, which has given rise to the popularization of display devices with a touch function. These display devices bring about tremendous convenience of use because a user can input signals by touching a touch display panel directly with a finger or other objects and can hence rely less, if at all, on such input devices as keyboards, mice, and remote controls than conventionally allowed.

One possible component with the touch function is photosensors. In order to integrate photosensors into a display device, sensing lines electrically connected to the photosensors must be disposed in addition to the data lines originally required to activate pixels. The disposition of sensing lines, however, reduces the aperture ratio of a display panel.

A display device capable of solving the foregoing problem is therefore needed.

### SUMMARY

The primary objective of the present disclosure is to provide a display device in which the number of sensing lines required to read from photosensors is reduced, and the display panel, therefore, has an increased aperture ratio.

Another objective of the present disclosure is to provide a touch sensing method that uses the disclosed display device to determine the position where the display device is touched by a to-be-detected object.

The disclosed display device includes: a display panel and; a backlight module, disposed under the display panel and including at least one visible light source and at least one infrared light source. The display panel includes: a first substrate; a first gate line, disposed on the first substrate; a second gate line, disposed on the first substrate and is adjacent to the first gate line; a first data line, disposed on the first substrate and intersects both the first gate line and the second gate line; a sensing line, disposed on the first substrate and adjacent to the first data line, wherein the sensing line intersects both the first gate line and the second gate line; and a photosensor, disposed on the first substrate and electrically connected to the sensing line, wherein the photosensor is further electrically connects to the first gate line.

In the disclosed display device, the display panel includes a photosensor and is therefore a photosensor-integrated display panel. In the display device of the present disclosure, each pixel of the display panel is an area defined by, for example, the first gate line, the second gate line, the first data line, and the sensing line; in other words, each pixel is provided with a data line on one side and a sensing line on the opposite side. By reducing the number of data lines and filling the positions occupied by sensing lines instead, the aperture ratio of the display panel of the disclosed display device is increased.

The present disclosure further provides a touch sensing method using the foregoing display device, and the method is carried out as follows. First, the foregoing display device is provided. Then, the infrared light source provides infrared light that propagates through the display panel, and the first gate line of the display panel provides a scanning signal to the photosensor. When a to-be-detected object approaches the display device, the infrared light is reflected to the photosensor to generate a photocurrent. The sensing line reads the photocurrent, and the photocurrent read is converted into a touch signal.

According to the disclosed touch sensing method, the position where the to-be-detected object touches the display device is identified with the infrared light source and the photosensor. Hence, even if the display panel is in a dark state, the photosensor can still perform its sensing operation to identify the position where the display device is touched by the to-be-detected object.

Other novel features of the disclosure will become more apparent from the following detailed description when taken in conjunction with the accompanying drawings.

### BRIEF DESCRIPTION OF THE DRAWINGS

FIG. 1 schematically shows the display device in Embodiment 1 of the present disclosure;

FIG. 2 schematically shows the circuitry of the display panel in Embodiment 1 of the present disclosure;

FIG. 3 shows a driving sequence diagram of the display device in Embodiment 1 of the present disclosure;

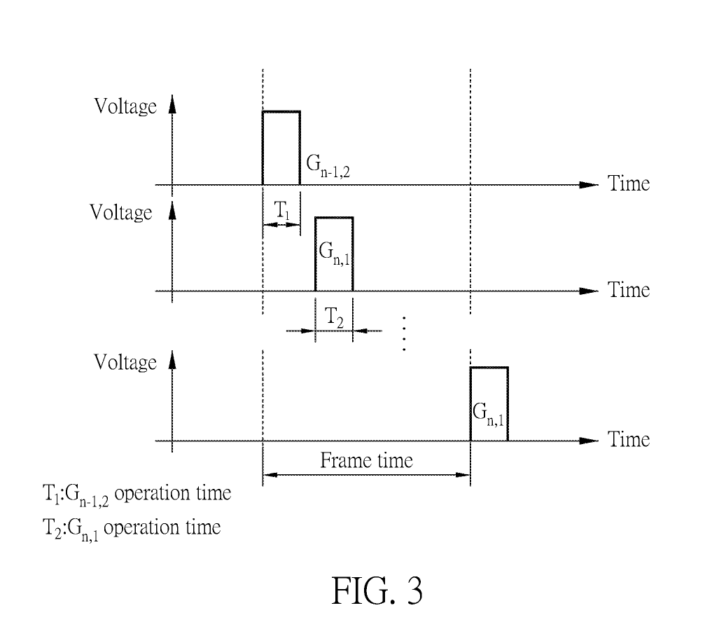

FIG. 4 shows another driving sequence diagram of the display device in Embodiment 1 of the present disclosure;

FIG. 5 shows still another driving sequence diagram of the display device in Embodiment 1 of the present disclosure;

FIG. 6 shows a block diagram of the display device in Embodiment 1 of the present disclosure;

FIG. 7 schematically shows the circuitry of the display panel in Embodiment 2 of the present disclosure;

FIG. 8 schematically shows the touch display panel in Embodiment 3 of the present disclosure;

FIG. 9 schematically shows the circuitry of the touch display panel in Embodiment 3 of the present disclosure;

FIG. 10 shows a driving sequence diagram of the display device in Embodiment 3 of the present disclosure;

FIG. 11 schematically shows the display device in Embodiment 4 of the present disclosure; and

FIG. 12 schematically shows the display device in Embodiment 5 of the present disclosure.

### DETAILED DESCRIPTION OF EMBODIMENT

The following embodiments when read with the accompanying drawings are made to clearly exhibit the above-mentioned and other technical contents, features and/or effects of the present disclosure. Through the exposition by means of the specific embodiments, people would further understand the technical means and effects the present disclosure adopts to achieve the above-indicated objectives. Moreover, as the contents disclosed herein should be readily understood and can be implemented by a person skilled in the art, all equivalent changes or modifications which do not depart from the concept of the present disclosure should be encompassed by the appended claims.

Furthermore, the ordinals recited in the specification and the claims such as “first”, “second” and so on are intended only to describe the elements claimed and imply or represent neither that the claimed elements have any proceeding ordinals, nor that sequence between one claimed element and another claimed element or between steps of a manufacturing method. The use of these ordinals is merely to differentiate one claimed element having a certain designation from another claimed element having the same designation.

Furthermore, the ordinals recited in the specification and the claims such as “above”, “on”, “overlie”, “below”, “under”, and “underlie” are intended not only directly contact with the other element, but also intended indirectly contact with the other element. Similarly, the ordinals recited in the specification and the claims such as “below”, or “under” are intended not only directly contact with the other element but also intended indirectly contact with the other element.

In addition, the features in different embodiments of the present disclosure can be mixed to form another embodiment.

### EMBODIMENT 1

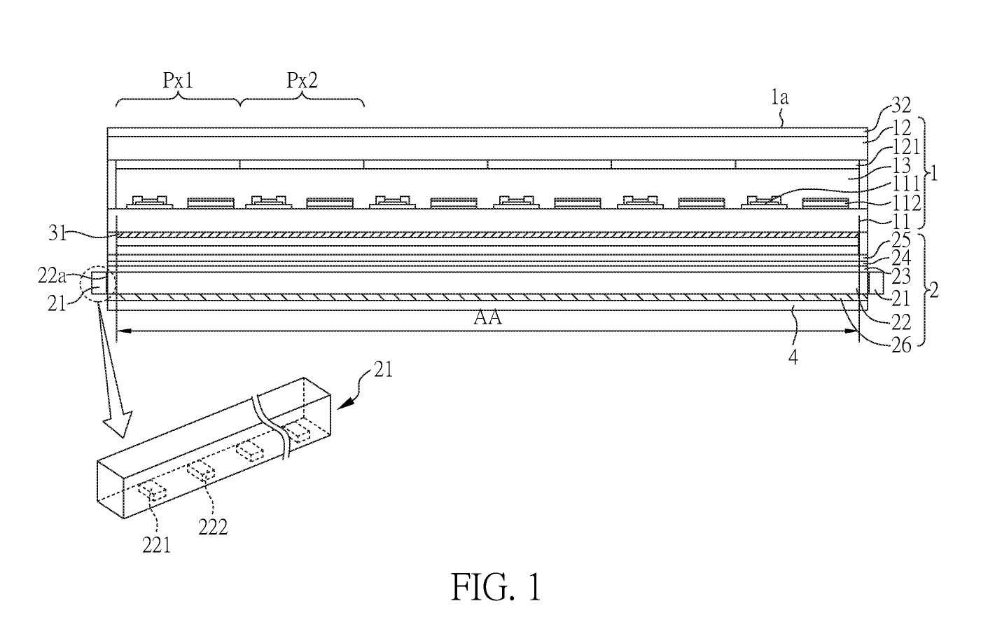

As shown schematically in FIG. 1, the display device in this embodiment includes: a display panel 1; and a backlight module 2 disposed under the display panel 1. The display panel 1 includes: a first substrate 11; a second substrate 12, disposed opposite to the first substrate 11; and a display medium 13, disposed between the first substrate 11 and the second substrate 12. The display panel 1 further includes a plurality of pixels, which include a first pixel area Px1 and a second pixel area Px2. The first pixel area Px1 is adjacent to the second pixel area Px2.

In this embodiment, the display medium 13 is a liquid crystal layer. In other embodiments of the present disclosure, however, the display medium 13 may be quantum dots (QDs), fluorescence molecules, phosphors, organic light emitting material, inorganic light emitting material (such as micro LED or mini LED), or other display media. In this embodiment, the first substrate 11 and the second substrate 12 may be glass substrates, plastic substrates or other flexible substrates, or films. When the first substrate 11 and the second substrate 12 are plastic substrates, other flexible substrates, or films, the display panel in this embodiment may be a flexible display panel.

In this embodiment, a plurality of transistors 111 and a plurality of photosensors 112 may be disposed on the first substrate 11, and a color filter layer 121 may be disposed on the second substrate 12. Although not shown, a black matrix layer may be further disposed on the second substrate 12 in this embodiment. In this embodiment, the first substrate 11 is a thin-film transistor substrate, and the second substrate 12 is a color filter substrate; but the present disclosure is not limited thereto. In one embodiment of the present disclosure, the color filter layer 121 may be disposed on the first substrate 11 instead such that the first substrate 11 is a color-filter-on-array (COA) thin-film transistor substrate. In another embodiment of the present disclosure, the black matrix layer (not shown) may be disposed on the first substrate 11 instead, thereby the first substrate 11 is a black-matrix-on-array (BOA) substrate.

As shown in FIG. 1, each of the first pixel area Px1 and the second pixel area Px2 is provided with a corresponding photosensor 112, but the present disclosure is not limited thereto. In other embodiments of the present disclosure, the number of the photosensors is not necessarily equal to that of the pixel areas. The number of the photosensors may be smaller than that of the pixel areas, as long as the position where the display panel is touched by a to-be-detected object can be identified.

In addition, the display panel in this embodiment may serve as a touch display panel if the photosensors 112 are uniformly disposed in the display area of the display panel. In other embodiments of the present disclosure, the photosensors 112 may be disposed only in a certain area of the display panel, and in that case, only the area disposed with the photosensors 112 can identify touch positions. Furthermore, there is no limitation on the targets to be identified by the photosensors 112 of the display device in this embodiment. For example, the targets to be identified may be touch positions, fingerprints, or both.

In this embodiment, the backlight module 2 of the display device includes: a light source module 21; a light guide plate 22, wherein the light source module 21 is disposed corresponding to an incident plane 22a of the light guide plate 22; a first diffuser plate 23, disposed on the light guide plate 22; a brightness enhancement film 24, disposed on the first diffuser plate 23; a second diffuser plate 25, disposed on the brightness enhancement film 24; and a reflective plate 26, disposed under the light guide plate 22. Thus, the backlight module 2 in this embodiment is an edge-lit backlight module. It should be understood, however, that the structure of the backlight modules suitable for use in the display device of the present disclosure are not limited to the foregoing structure and the backlight module may include other films or layers or omit some of the aforesaid films or layers as appropriate.

The display device in this embodiment further includes: a first polarizer 31 disposed between the display panel 1 and the backlight module 2; a second polarizer 32 disposed on the second substrate 12; and a bezel 4 disposed under the backlight module 2.

In this embodiment, the light source module 21 of the display device includes at least one visible light source 221 and at least one infrared light source 222. The visible light source 221 and the infrared light source 222 are disposed corresponding to the incident plane 22a of the light guide plate 22. Here, the visible light source 221 serves as the light source of the display panel 1, and the infrared light source 222 serves as the light source for touch position identification. When the light source module 21 includes a plurality of visible light sources 221 and a plurality of infrared light sources 222, the visible light sources 221 and the infrared light sources 222 may be alternately or randomly arranged, as long as the visible light emitted from the visible light sources 221 can reach the display panel 1, and the infrared light emitted from the infrared light sources 222 can be reflected to and thus received by the photosensors 112. In this embodiment, plural visible light sources 221 and plural infrared light sources 222 are arranged in an alternate manner. Besides, depending on circuit design or user needs, the visible light sources 221 and the infrared light sources 222 may be configured to be activated at the same time or separately.

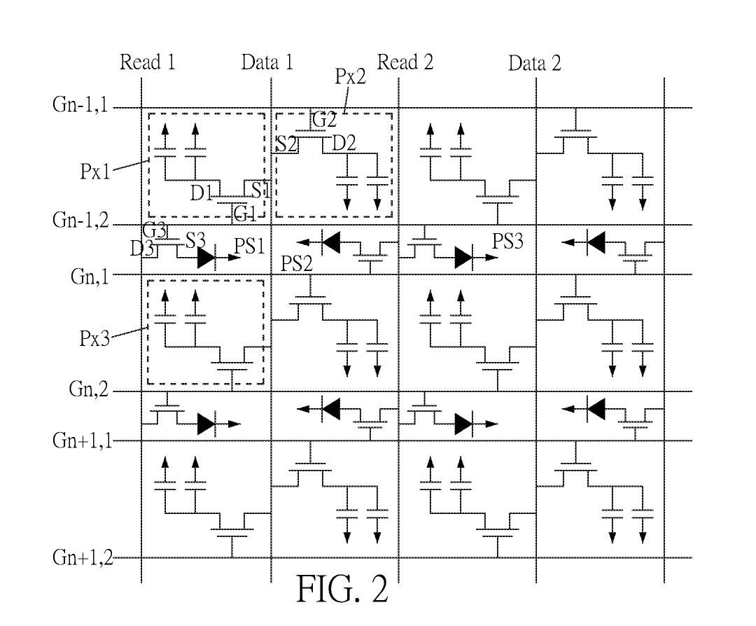

The circuit overlying the first substrate 11 of the display panel 1 is designed as follows. Referring to FIG. 2 for the circuitry of the display panel in this embodiment, the display panel includes: a first substrate (not shown); a first gate line Gn−1,2 disposed on the first substrate (not shown); a second gate line Gn−1,1 disposed on the first substrate (not shown) and adjacent to the first gate line Gn−1,2; a first data line Data1 disposed on the first substrate (not shown) and intersecting the second gate line Gn−1,1 and the first gate line Gn−1,2; a sensing line Read1 disposed on the first substrate (not shown) and adjacent to the first data line Data1, wherein the sensing line Read1 intersects the second gate line Gn−1,1 and the first gate line Gn−1,2; and a first photosensor PS1 disposed on the first substrate (not shown) and electrically connected to the sensing line Read1, wherein and the photosensor PS1 is further electrically connected to the first gate line Gn−1,2.

The second gate line Gn−1,1, the first gate line Gn−1,2, the first data line Data1, and the sensing line Read1 define the first pixel area Px1. The first pixel area Px1 includes a first transistor, which comprises a first gate G1, a first source S1, and a first drain D1. Here, the first gate line Gn−1,2 provides a scanning signal to the first gate G1 to turn on the first transistor, and the first data line Data1 provides a data signal to the first source S1. Additionally, the second gate line Gn−1,1, the first gate line Gn−1,2, the first data line Data1, and another sensing line Read2 define the second pixel area Px2. The second pixel area Px2 includes a second transistor, which comprises a second gate G2, a second source S2, and a second drain D2. Here, the second gate line Gn−1,1 provides a scanning signal to the second gate G2 to turn on the second transistor, and the first data line Data1 provides a data signal to the second source S2. Moreover, in this embodiment, a third gate line Gn,1, a fourth gate line Gn,2, the first data line Data1, and the sensing line Read1 define a third pixel area Px3.

In this embodiment, the photosensors PS (e.g., PS1, PS2, and PS3) are located outside their respective pixel areas. For example, the photosensor PS1 is disposed outside the first pixel area Px1, and the photosensor PS2 is disposed outside the second pixel area Px2. More specifically, the first photosensor PS1 and the second photosensor PS2 are disposed between the first gate line Gn−1,2 and the adjacent third gate line Gn,1; in other words, the first photosensor PS1 and the second photosensor PS2 are disposed between the first gate line Gn−1,2 of the first pixel area Px1 and the third gate line Gn,1 of the third pixel area Px3. Each photosensor PS is a diode-based photosensor including a transistor. For example, the first photosensor PS1 includes a transistor comprising a third gate G3, a third source S3, and a third drain D3. During a first time period T1, the first gate line Gn−1,2 provides a scanning signal to the third gate G3, and the first photosensor PS1 generates a photocurrent when receiving a light signal, thereby turning on the transistor of the photosensor PS1, with the third source S3 and the third drain D3 transmitting the photocurrent to the sensing line Read1. When receiving a light signal during the first time period T1, the third photosensor PS3 also generates a photocurrent and thereby turns on the transistor of the third photosensor PS3 to transmit the photocurrent to the sensing line Read2. During a second time period T2, the third gate line Gn,1 provides a scanning signal, and the second photosensor PS2 generates a photocurrent when receiving a light signal, thereby turning on the transistor of the second photosensor PS2 to transmit the photocurrent to the sensing line Read2. As the second photosensor PS2 and the third photosensor PS3 will not be turned on at the same time, the sensing line Read2 can read the photocurrent of the second photosensor PS2 and the photocurrent of the third photosensor PS3 at different time points respectively. In this embodiment, each two adjacent photosensors are electrically connected to different gate lines respectively. Besides, the photosensors PS in this embodiment are configured to sense light in the infrared band, whose wavelengths range from 780 nm to 1000 nm. It should be pointed out that the first time period T1 and the second time period T2 may be immediately adjacent to each other, meaning that right after the first gate line Gn−1,2 provides a scanning signal, the third gate line Gn,1 provides another scanning signal. Alternatively, there may be a blanking time or other time interval between the first time period T1 and the second time period T2. However, the present disclosure is not limited thereto.

The display panel in this embodiment further includes a second data line Data2. The second data line Data2 is disposed on the first substrate (not shown) and intersects the second gate line Gn−1,1 and the first gate line Gn−1,2. The sensing line Read2 is disposed between the first data line Data1 and the second data line Data2. In other words, the display panel in this embodiment is so designed that the sensing lines Read1 and Read2 and the data lines (i.e., the first data line Data1 and the second data line Data2) are alternately arranged.

With continued reference to FIG. 2, the first transistor of the first pixel area Px1 and the second transistor of the second pixel area Px2 are electrically connected to the first data line Data1; therefore, the first gate G1 of the first transistor and the second gate G2 of the second transistor must be driven by two different gate lines (i.e., the first gate line Gn−1,2 and the second gate line Gn−1,1) respectively. With the first transistor and the second transistor electrically connected to the first data line Data1, fewer data lines are used, and the positions otherwise occupied by more data lines are used to accommodate the sensing lines Read1 and Read2.

In the conventional photosensor-integrated display panels, each pixel area is provided with two data lines on two lateral sides respectively, and a sensing line has to be additionally disposed, resulting in the aperture ratio of the display panel reduced. In the display device of this embodiment, by contrast, the first transistor of the first pixel area Px1 and the second transistor of the second pixel area Px2 are electrically connected to the first data line Data1, meaning the first data line Data1 is disposed on only one side of the first pixel area Px1 and only one side of the second pixel area Px2, wherein the sensing lines Read1 and Read2 respectively disposed on the opposite side of the first pixel area Px1 and the opposite side of the second pixel area Px2. By reducing the number of data lines and disposing the sensing lines Read1 and Read2 at positions originally occupied by data lines, the display panel in this embodiment, therefore, has a higher aperture ratio than the conventional photosensor-integrated display panels.

In the display panel of this embodiment, the first data line Data1, the second data line Data2, and the sensing lines Read1 and Read2 extend in substantially the same direction, for example, the first direction; the second gate line Gn−1,1, the first gate line Gn−1,2, and the other gate lines Gn,1, Gn,2, Gn+1,1, and Gn+1,2 extend in substantially the same direction, for example, the second direction, and the second direction is different from the first direction. In one embodiment, the first data line Data1, the second data line Data2, and the sensing lines Read1 and Read2 may use different ICs or be integrated into the same IC.

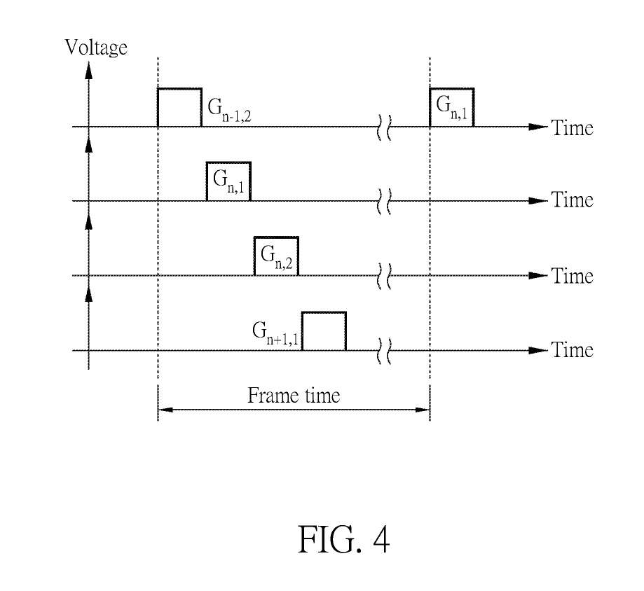

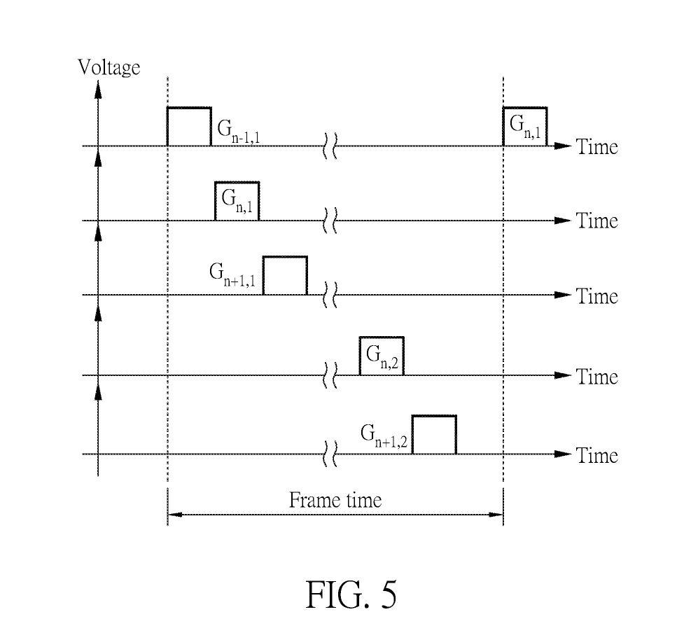

It should be pointed out that, in this embodiment, signals need not be transmitted sequentially to the gate lines as shown in the gate driving sequence diagram in FIG. 4. The gate driving sequence diagram in FIG. 5 is also feasible, in which signals are transmitted first to odd-numbered gate lines and then to even-numbered gate lines. This embodiment has no limitation on the time sequence of signal transmission by the gate lines.

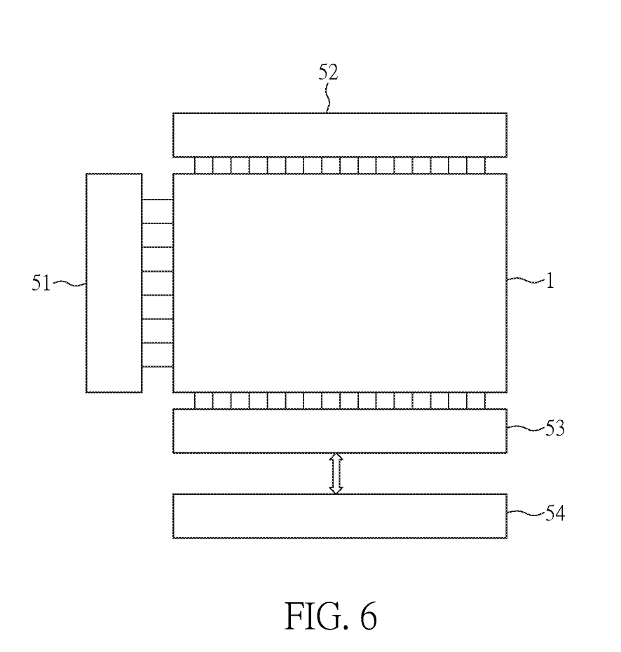

FIG. 6 shows a block diagram of the display device in this embodiment. As shown in FIG. 2 and FIG. 6, the display device in this embodiment further includes a gate driver 51, a source driver 52, an analog front-end (AFE) 53, and a processor 54, in addition to the display panel 1 described above. The gate driver 51 is configured to provide scanning signals to the second gate line Gn−1,1, the first gate line Gn−1,2, and the other gate lines Gn,1, Gn,2, Gn+1,1, and Gn+1,2. The source driver 52 is configured to provide data signals to the first data line Data1, the second data line Data2, and the other data lines. The analog front-end 53 is electrically connected to the sensing lines Read1 and Read2. The processor 54 is electrically connected to the analog front-end 53. In this embodiment, the analog front-end 53 may be replaced by or used in conjunction with an analog-to-digital converter (ADC). Besides, examples of the processor 54 include but are not limited to microchips, embedded systems, and other similar processors.

Referring to FIG. 1 and FIG. 2, the display panel in this embodiment identifies touch positions generally through the following steps. To begin with, the infrared light sources 222 provide infrared light, which. propagates through the display panel 1, and the first gate line Gn−1,2 provides a scanning signal to the transistor of the first photosensor PS1. When a to-be-detected object approaches the display device, in particular when the to-be-detected object touches the upper surface 1a of the display panel 1, the infrared light cannot pass through the to-be-detected object and is therefore reflected by the to-be-detected object to the first photosensor PS1, and the diode of the first photosensor PS1 generates a relatively large photocurrent when it has detected light. Conversely, when the to-be-detected object is not close to the display device, or not in contact with the upper surface 1a of the display panel 1, the infrared light passes through the upper surface 1a of the display panel 1 and will not be reflected to the first photosensor PS1, and the diode of the first photosensor PS1 generates a relatively small dark current or no current is generated. Next, the sensing line Read1 reads the light current or dark current, and the analog front-end 53 (see FIG. 6) converts the light current or dark current into a touch signal. Lastly, the processor 54 reconstructs the diagram of the touch signal according to pixel frames in order to identify the position where the display panel is touched by the to-be-detected object.

As stated above, the display device in this embodiment uses the infrared light sources and the photosensors to sense touch signals and thereby identify where the display device is touched by a to-be-detected object. In particular, the infrared light sources can work regardless of whether the display panel is in the bright or dark states, so the visible light sources will not have an adverse effect on the amount of light input into (i.e., sensed by) the photosensors or on the intensity of electrical signals generated by photoelectric conversion. In addition, as the photosensors are configured to sense light in the infrared band, they can sense such light and thereby identify the touch position of a to-be-detected object on the display device even when the display panel is a dark state.

### EMBODIMENT 2

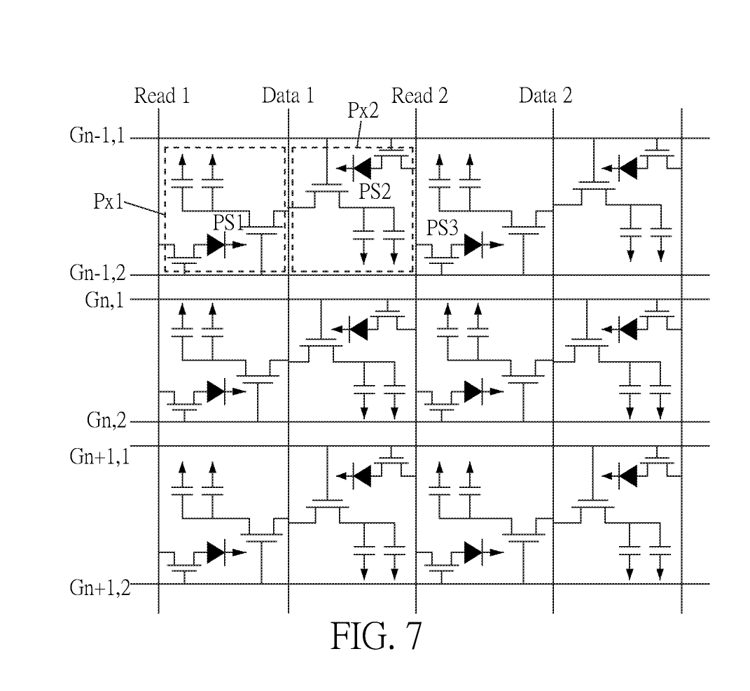

Please refer to FIG. 7 for the circuitry of the display panel in this embodiment. The display device in this embodiment is generally the same as that in embodiment 1 except for the following.

In the display device in Embodiment 1, as shown in FIG. 1, the photosensors PS are disposed outside their respective pixel areas; for example, the first photosensor PS1 is disposed outside the first pixel area Px1, and the second photosensor PS2 is disposed outside the second pixel area Px2. By contrast, referring to FIG. 7, the display device in Embodiment 2 is so designed that at least some of the photosensors PS are disposed inside their respective pixel areas. For example, the first photosensor PS1 lies inside the first pixel area Px1, and the second photosensor PS2 lies inside the second pixel area Px2. Although disposing a photosensor PS inside a pixel area may change the aperture ratio of the pixel area, the effect of the change in aperture ratio can be reduced by using a proper pixel color. For example, the human eye is relatively sensitive to the green color, so a pixel with a relatively low aperture ratio can be designed as a green pixel; the human eye is relatively insensitive to the blue color, so a pixel with a relatively high aperture ratio can be designed as a blue pixel. The disclosed display device may have some of its photosensors outside their respective pixel areas and the others inside their respective pixel areas, depending on designers' considerations. In addition, the ratio of the number of photosensors to the number of pixel areas of the disclosed display device is not necessarily 1:1. Depending on designers' considerations, it is feasible to dispose a plurality of photosensors only in a specific area (e.g., a peripheral area or an identification area) of the display device.

### EMBODIMENT 3

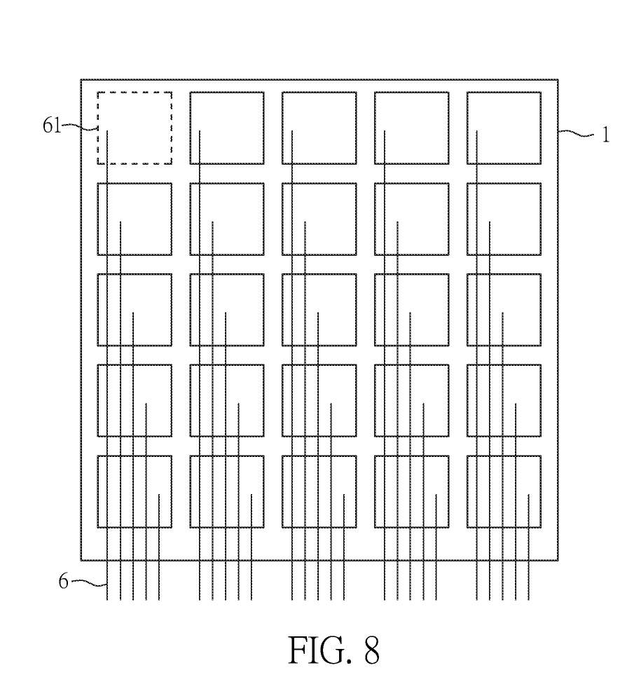

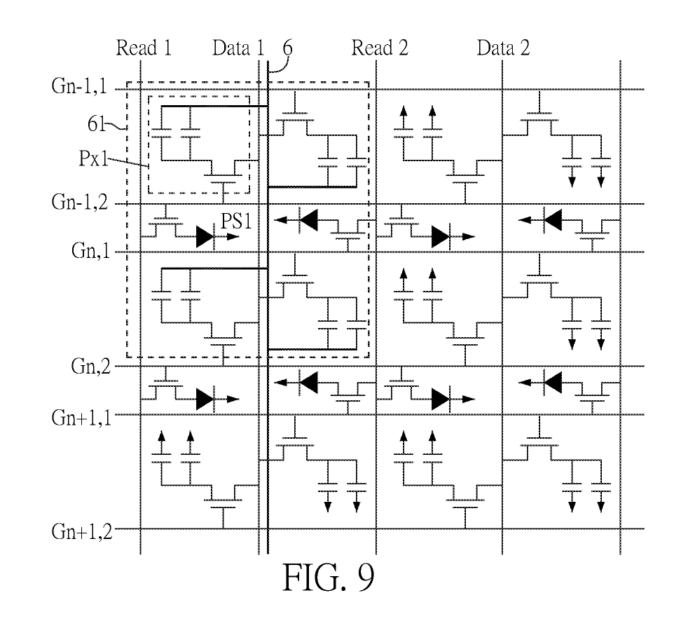

Please refer to FIG. 8 for the touch display panel in this embodiment, and FIG. 9 for the circuitry of the touch display panel in this embodiment. The display device in this embodiment is generally the same as that in Embodiment 1 except for the following.

As shown in FIG. 8, the display panel 1 in this embodiment is a touch display panel and further includes touch electrodes 61 and touch signal lines 6. The touch electrodes 61 and the touch signal lines 6 are electrically connected.

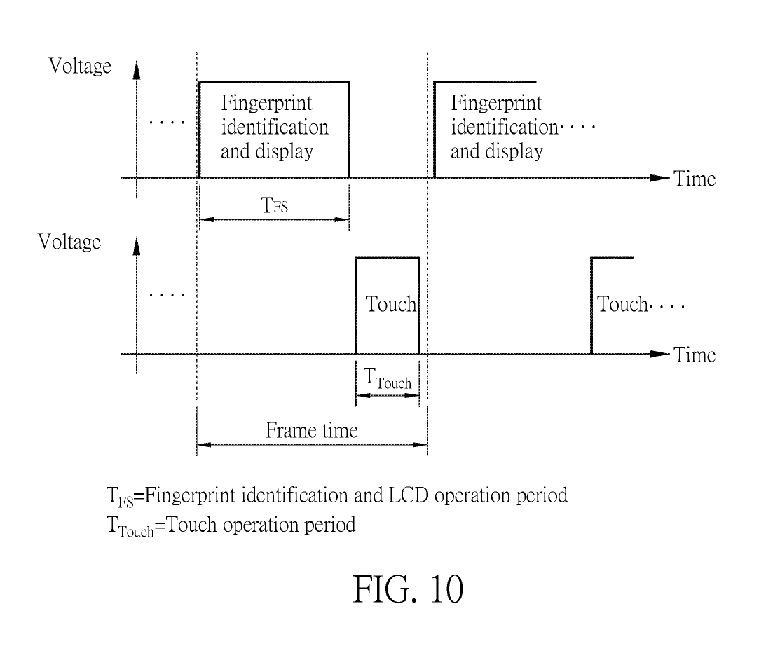

As shown in FIG. 9, the touch signal line 6 is disposed adjacent to the first data line Data1, wherein the touch signal line 6 and the first data line Data1 may be made by the same manufacturing process or by different manufacturing processes respectively. The present disclosure, however, is not limited to the above arrangement. The touch signal line 6 may alternatively be disposed under or above the first data line Data1, form a stacked or laminated structure with the first data line Data1. Referring to FIG. 10 for a driving sequence diagram of the display device in this embodiment, in a certain frame time, the touch display panel performs both sensing and displaying functions in a third time period Tfs and performs the touch function in a fourth time period Ttouch different from the third time period Tfs.

### EMBODIMENT 4

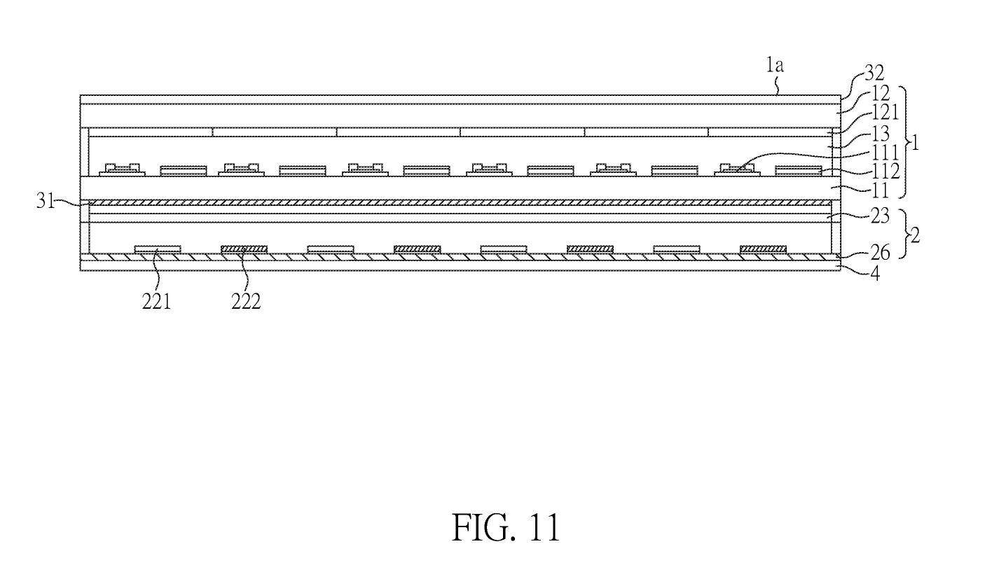

Please refer to FIG. 11 for the display device in this embodiment. The display device in this embodiment is generally the same as that in Embodiment 1 except for the following.

While the backlight module 2 in the display device in embodiment 1 is an edge-lit backlight module as shown in FIG. 1, the backlight module 2 in the display device in embodiment 4 is a direct-lit backlight module as shown in FIG. 11, with the visible light sources 221 and infrared light sources 222 disposed between the bezel 4 and the display panel 1. The backlight module 2 in Embodiment 4 further includes a diffuser plate 23, and the visible light sources 221 and the infrared light sources 222 are disposed below the diffuser plate 23. Please note that backlight modules suitable for use in the display device of the present disclosure are not limited to those of the foregoing structure and may include other films or layers or omit some of the aforesaid films or layers as appropriate.

### EMBODIMENT 5

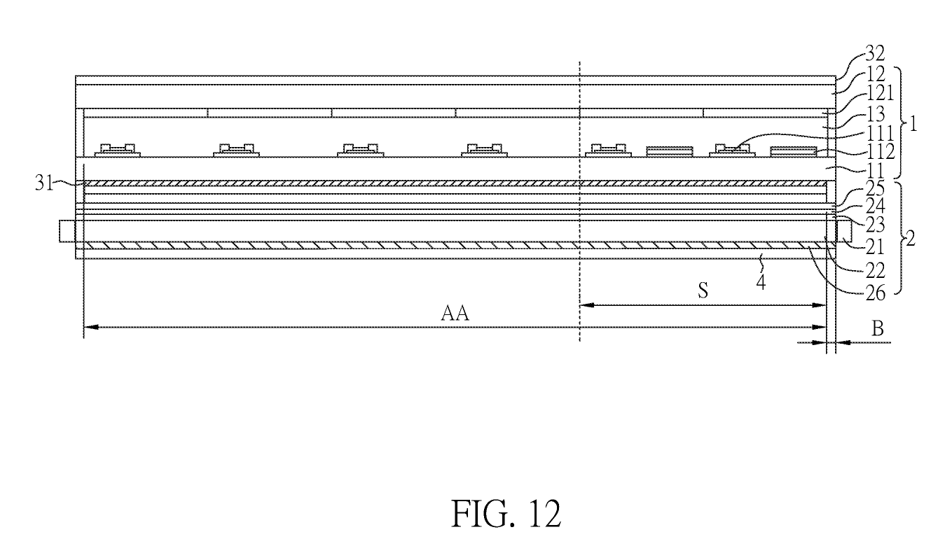

Please refer to FIG. 12 for the display device in this embodiment. The display device in this embodiment is generally the same as that in Embodiment 1 except for the following.

In Embodiment 1, as shown in FIG. 1, the photosensors are disposed within the display area AA of the display panel 1 of the display device. In Embodiment 5, as shown in FIG. 12, the display area AA of the display panel 1 of the display device includes an identification area S next to a peripheral area B, and the photosensors are disposed only in the identification area S.

A display device or touch display device made according to the foregoing embodiments of the present disclosure can be used in any electronic device known in the related art that requires a display screen, i.e., any electronic device that is designed to display images, such as a display, a mobile phone, a laptop computer, a video camera, a still camera, a music player, a mobile navigation device, a television set, or the like.

Although the present disclosure has been explained in relation to its embodiment, it is to be understood that many other possible modifications and variations can be made without departing from the spirit and scope of the disclosure as hereinafter claimed.

What is claimed is:

1. A display device, comprising:
a display panel, comprising:
a first substrate;
a first gate line, disposed on the first substrate;
a second gate line, disposed on the first substrate and adjacent to the first gate line;
a first data line, disposed on the first substrate and intersecting the first gate line and the second gate line;
a sensing line, disposed on the first substrate and adjacent to the first data line, wherein the sensing line intersects the first gate line and the second gate line; and
a photosensor, disposed on the first substrate and electrically connected to the sensing line, wherein the photosensor is further electrically connected to the first gate line; and
a backlight module, disposed under the display panel and comprising:
at least one visible light source; and
at least one infrared light source.

2. The display device of claim 1, wherein the first gate line, the second gate line, the first data line, and the sensing line define a first pixel area, and at least a part of the photosensor is disposed inside the first pixel area.

3. The display device of claim 1, wherein the first gate line, the second gate line, the first data line, and the sensing line define a first pixel area, and the photosensor is disposed outside the first pixel area.

4. The display device of claim 1, wherein the display panel further comprises a touch signal line, and the touch signal line is disposed adjacent to, under, or above the first data line.

5. The display device of claim 4, wherein the display panel further comprises a touch electrode electrically connects to the touch signal line.

6. The display device of claim 1, wherein the display panel further comprises a second data line, the second data line is disposed on the first substrate and intersects the first gate line and the second gate line, and the sensing line is disposed between the first data line and the second data line.

7. The display device of claim 1, further comprising an analog front-end or an analog-to-digital converter, wherein the analog front-end or the analog-to-digital converter is electrically connected to the sensing line.

8. The display device of claim 1, wherein the backlight module further comprises a diffuser plate, and the visible light source and the infrared light source are disposed under the diffuser plate.

9. The display device of claim 1, wherein the backlight module further comprises a light guide plate, and the visible light source and the infrared light source are disposed corresponding to an incident plane of the light guide plate.

10. The display device of claim 1, wherein the photosensor is configured to sense light in the infrared band.

11. A touch sensing method, comprising the steps of:
providing a display device, wherein the display device comprises:
a display panel, comprising:
a first substrate;
a first gate line, disposed on the first substrate;
a second gate line, disposed on the first substrate and adjacent to the first gate line;
a first data line, disposed on the first substrate and intersecting the first gate line and the second gate line;
a sensing line, disposed on the first substrate and adjacent to the first data line, wherein the sensing line intersects the first gate line and the second gate line; and
a photosensor, disposed on the first substrate and electrically connected to the sensing line, wherein the photosensor is further electrically connected to the first gate line; and
a backlight module, disposed under the display panel and comprising:
at least one visible light source; and
at least one infrared light source;
providing infrared light by the infrared light source and providing a scanning signal to the photosensor by the first gate line of the display panel, wherein the infrared light propagates through the display panel, and the infrared light is reflected to the photosensor to generate a photocurrent when a to-be-detected object approaches the display device; and
reading the photocurrent by the sensing line, and converting the photocurrent into a touch signal.

12. The method of claim 11, wherein the first gate line, the second gate line, the first data line, and the sensing line define a first pixel area, and at least a part of the photosensor is disposed inside the first pixel area.

13. The method of claim 11, wherein the first gate line, the second gate line, the first data line, and the sensing line define a first pixel area, and the photosensor is disposed outside the first pixel area.

14. The method of claim 11, wherein the display panel further comprises a touch signal line, and the touch signal line is disposed adjacent to, under, or above the first data line.

15. The method of claim 14, wherein the display panel further comprises a touch electrode electrically connects to the touch signal line.

16. The method of claim 11, wherein the display panel further comprises a second data line, the second data line is disposed on the first substrate and intersects the first gate line and the second gate line, and the sensing line is disposed between the first data line and the second data line.

17. The method of claim 11, wherein the display device further comprises an analog front-end or an analog-to-digital converter, and the analog front-end or the analog-to-digital converter is electrically connected to the sensing line.

18. The method of claim 11, wherein the backlight module further comprises a diffuser plate, and the visible light source and the infrared light source are disposed under the diffuser plate.

19. The method of claim 11, wherein the backlight module further comprises a light guide plate, and the visible light source and the infrared light source correspond to an incident plane of the light guide plate.

20. The method of claim 11, wherein the photosensor is configured to sense light in the infrared band.
